(19) United States
(12) Patent Application Publication
(10) Pub. No.: US 2009/0234728 A1
(43) Pub. Date: Sep. 17, 2009

(54) ADVERTISING INTRODUCTORY INFORMATION INCLUDING MULTIPLE PROFILES

(75) Inventors: Frank Willuns, Voerde (DE); Miika Laaksonen, Espoo (FI)

Correspondence Address: Locke Lord Bissell & Liddell LLP;Attn: IP Docketing, Three World Financial Center, New York, NY, 10281-2101, US

(73) Assignee: NOKIA CORPORATION, Espoo (FI)

(21) Appl. No.: 12/048,007

(22) Filed: Mar. 13, 2008

(51) Int. Cl. G06Q 30/00

(52) U.S. Cl. 705/14

(57) ABSTRACT

The present invention, in accordance with at least one embodiment, is directed to conveying introductory information between an advertising apparatus (advertiser) and a scanning apparatus (scanner). As part of providing introductory information, an advertiser may inform a scanner of identification information and one or more communication profiles available on the advertiser that are usable for accessing various functionality. Identification and profile information may be provided in the same message or in multiple messages, and may be sent over an established wireless connection between apparatuses or as part of a broadcast message that may be received in the scanner without the need to first negotiate a formal wireless link to the advertiser.

### BACKGROUND

1. Field of Invention

The present invention relates to advertising information available in a apparatus, and more specifically, to a system and/or strategy for advertising at least apparatus identification and communication profile information in an apparatus that may have a plurality of profiles.

2. Background

Wireless apparatuses have become prevalent in today's society. This popularity may, at least in part, be fueled by rapid technological development in the area of multifunction wireless communication apparatuses (WCD). Consumers may now replace common standalone productivity apparatuses like computers, laptops, facsimile machines, personal digital assistants, etc. with a solitary apparatus capable of performing all of these functions. Apparatuses with these abilities have been embraced by business people who often find that work can now be completed during time that was previously wasted (commutes to and from work, home, etc.)

However, while a WCD may be empowered with many beneficial features, the small size and power constraints of these apparatuses may also create a hindrance for the user. The operator interfaces installed in these apparatuses are often small, and therefore, may not be conducive to high throughput. As a result, users may rely on peripheral input apparatuses such as keyboards, mice, headsets, etc. in order to perform their work. Further, the small size of many apparatuses today also implies that there is a lack of physical connections to connect wired apparatuses. Therefore, a WCD should not only be able to support wireless communications with one peripheral apparatus, but it should also be able to support connections with multiple peripheral apparatuses being operated concurrently.

Apparatuses may interact with each other through the provision of introductory information that communicates information that may be used to determine both whether to, and how to, connect to another apparatus. Introductory information may include at least apparatus identification information and interface and/or functionality-related information communicated, for example, in the form of a communication profile. Communication profiles may, for example, define how applications on an apparatus may wirelessly gain access to remote resources residing on another apparatus. Simple apparatuses (e.g., sensors, headsets, computer mice, etc.) may include a relatively limited command set accessible by other apparatuses, and therefore, may only include a single communication profile. However, complex apparatuses may include more than one communication profile corresponding to various wirelessly-accessible functionalities.

In at least one scenario, a more complex wireless communication apparatus may assume various roles when interacting with other apparatuses. A apparatus including an alphanumeric keyboard may, for example, serve as a user input interface providing information to a apparatus without such capability via wireless communication. The same complex apparatus may also include a cellular data communication profile that may allowing another apparatus (e.g., a laptop or other computing apparatus) to access the internet, a data storage profile for storing information received by wireless communication to a fixed or removable medium, a video streaming profile, etc. However, difficulty may be experienced when trying to advertise various profiles to potential consumers as a component of the overall introductory information.

### SUMMARY

The present invention may include a method, apparatus, computer program and system for conveying introductory information between an advertising apparatus (advertiser) and a scanning apparatus (scanner). As part of providing introductory information, an advertiser may inform a scanner of identification information and one or more communication profiles available on the advertiser that are usable for accessing various functionality. Identification and profile information may be provided in together in the same message, or as part of multiple messages. Introductory information may be conveyed using an established wireless connection between apparatuses, or alternatively, may be part of a broadcast message that may be received in the scanner without the need to first negotiate a formal wireless link to the advertiser.

In at least one embodiment of the present invention, an advertising strategy may be employed to facilitate the communication of introductory information that can account for multiple communication profiles. This strategy for communicating introductory information from apparatuses having multiple profiles, or multiple introduction advertising (MIA) strategy, may advertise different sets of introductory information in different patterns that may indicate to a receiving apparatus that more than one profile is accessible on the advertiser.

For example, an MIA strategy may communicate different sets of introductory information repeatedly in a set sequence. During this interaction, another apparatus may establish a wireless link to the advertiser over which identification information and information related to available profiles may be transferred. Exemplary communication profile information may include the identification of individual communication profiles, a list of all available communication profiles, a flag indicating that additional communication profiles are available, etc. In another exemplary configuration of the present invention, the MIA strategy may utilize a connectionless data transfer. For example, an advertising apparatus may broadcast introductory information including identification and profile information in a set pattern without having to deal with the formality of first establishing a wireless link with another apparatus.

### DESCRIPTION OF DRAWINGS

The invention may be further understood from the following detailed description of various exemplary embodiments, taken in conjunction with appended drawings, in which:

FIG. 1A discloses a modular description of an exemplary wireless communication device usable with at least one embodiment of the present invention.

FIG. 1B discloses an exemplary structural description of the wireless communication device previously described in FIG. 1A.

FIG. 2 discloses an exemplary Bluetooth™ protocol stack and an Ultra Low Power Bluetooth™ protocol stack usable with at least one embodiment of the present invention.

FIG. 3A discloses an example of multiple wireless peripheral apparatuses attempting to communicate concurrently with a dual-mode radio modem in accordance with at least one embodiment of the present invention.

FIG. 3B discloses further detail pertaining to the example of FIG. 3A regarding operational enhancements for managing the operation of a dual-mode modem in accordance with at least one embodiment of the present invention.

FIG. 4 discloses a more detailed example of an Ultra Low Power Bluetooth™ protocol stack in accordance with at least one embodiment of the present invention.

FIG. 5A discloses an example of communications between an advertiser and a receiving apparatus in accordance with at least one embodiment of the present invention.

FIG. 5B discloses exemplary Ultra Low Power Bluetooth™ message structures usable in accordance with at least one embodiment of the present invention.

FIG. 6 discloses an exemplary scenario wherein a apparatus may include multiple communication profiles in accordance with at least one embodiment of the present invention.

FIG. 7 discloses exemplary service class Universally Unique Identifiers (UUID) that may be implemented in accordance with at least one embodiment of the present invention.

FIG. 8A discloses an exemplary multiple introduction advertising strategy in accordance with at least one embodiment of the present invention.

FIG. 8B discloses an alternative example of a multiple introduction advertising strategy in accordance with at least one embodiment of the present invention.

FIG. 9 discloses an exemplary connectionless multiple introduction advertising strategy in accordance with at least one embodiment of the present invention.

FIG. 10 discloses an exemplary process flowchart wherein an advertiser may utilize a multiple introduction strategy in accordance with at least one embodiment of the present invention.

### DESCRIPTION OF EXEMPLARY EMBODIMENTS

While the present invention has been described below in terms of multiple exemplary embodiments, various changes can be made therein without departing from the spirit and scope of the invention, as described in the appended claims.

### I. Wireless Communication Device

As previously set forth, the present invention, in accordance with at least one embodiment, may be implemented utilizing a variety of apparatuses. Therefore, establishing an understanding of wirelessly-enabled apparatuses that may be used in implementing these various exemplary embodiments may aid in comprehending the following disclosure. For example, in the case of a cellular handset, palmtop or laptop computer, wireless communicator or other handheld wireless apparatus, the integrated data handling capabilities of the apparatus may play an important role in facilitating transactions between the transmitting and receiving apparatuses.

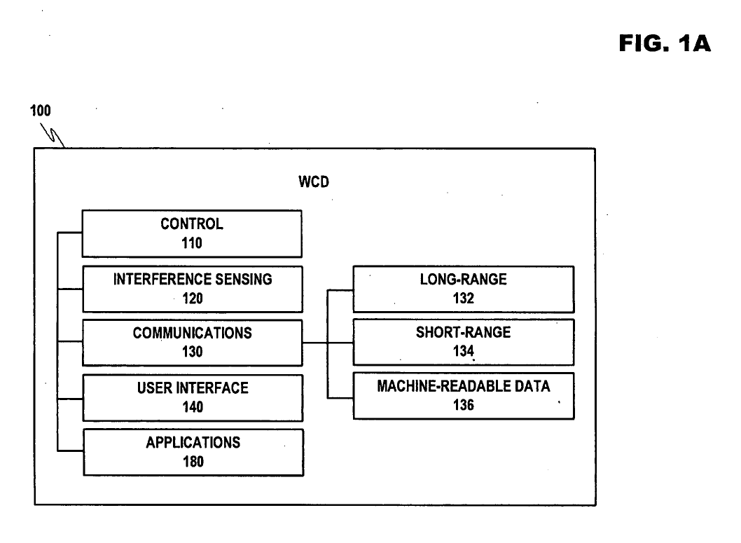

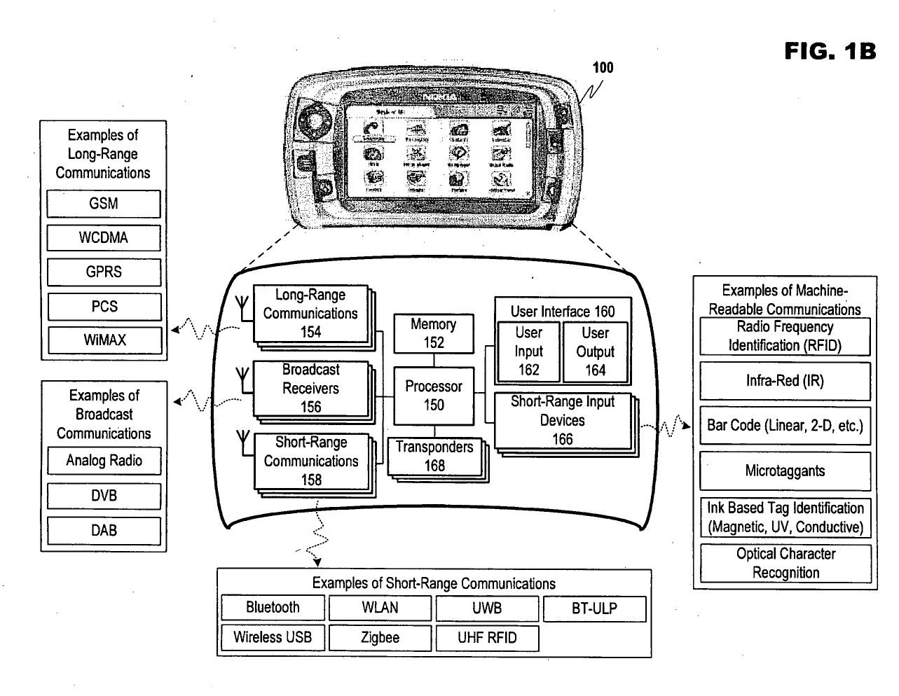

FIG. 1A discloses an exemplary modular layout for a wireless communication device usable with various exemplary embodiments of the present invention. WCD 100 may be represented as an organization functional modules corresponding to the various operational aspects/elements of the apparatus. These functional modules may be implemented by various combinations of software and/or hardware components as previously discussed below.

Control module 110 may regulate the operation of the apparatus. Inputs into control module 110 may be received from various other modules included within WCD 100. For example, interference sensing module 120 may use various techniques known in the art to sense sources of environmental interference within transmission range of WCD 100. Control module 110 may interpret these inputs, and in response, may issue control commands to other modules.

Communications module 130 may generally incorporate all of the wired and/or wireless communication features of WCD 100. As shown in FIG. 1A, communications module 130 may include, for example, long-range communication module 132, short-range communication module 134 and machine-readable data module 136 (e.g., for NFC). Communications module 130 may utilizes at least these sub-modules to receive a multitude of different types of communication from both local and long distance sources, and to transmit data to apparatuses within the transmission range of WCD 100. Communications module 130 may be triggered by control module 110, or by control resources local to the module responding to sensed messages, environmental influences and/or other apparatuses in proximity of WCD 100.

User interface module 140 includes visual, audible and tactile elements which allow a user to receive data from, and enter data into, the apparatus. The data entered by a user may be interpreted by control module 110 to affect the behavior of WCD 100. User-inputted data may also be transmitted by communications module 130 to other apparatuses within transmission range (e.g., for wireless communication). Conversely, other apparatuses may also send information to WCD 100 via communications module 130, and control module 110 may cause this information to be transferred to user interface module 140 for presentment to the user.

Applications module 180 may incorporate all other hardware and/or software resources on WCD 100. Applications in this module may include sensors, interfaces, utilities, interpreters, data applications, or any other functionality executable on WCD 100. Applications within application module 180 may be invoked by control module 110 to, for example, read information provided by various modules and in turn supply information to requesting modules.

FIG. 1B discloses an exemplary structural layout for WCD 100 according to an embodiment of the present invention that may be used to implement the functionality of the modular system previously described with respect to FIG. 1A. Processor 150 may control overall apparatus operation, for example, by interfacing with other elements in WCD 100, like communication sections 154, 158 and 166. Processor 150 can be implemented with one or more microprocessors that are each capable of executing software instructions stored in memory 152.

Memory 152 may include fixed and/or removable memory media (e.g., magnetic, optical, etc.) that may comprise, for example, random access memory (RAM), read only memory (ROM), rewritable solid state memory like flash, etc. Memory 152 may store information in the form of data and software components (also referred to herein as modules). The data stored by memory 152 may be associated with particular control, application or database modules such as command databases, contacts databases or business databases for scheduling, email, etc.

The software components stored by memory 152 may include computer-readable instructions that can be executed by processor 150. Various types of software components may be stored in memory 152. For instance, memory 152 may store software components that control communication sections 154, 158 and 166. Memory 152 may also store software components related to operating system components, user interfaces, applications, utilities, security, entertainment and any communication utilities modules required to support WCD 100.

Long-range communications 154 may perform activities related to the exchange of information over large geographic areas (such as cellular network communication). These long-range network technologies have traditionally been classified by generations, starting in the late 1970s to early 1980s with first generation (1G) analog cellular telephones that provided baseline voice communication, to modern digital cellular telephones. Global System for Mobile Communications (GSM) is an example of a widely employed 2G digital cellular network communicating in the 900 MHZ/1.8 GHZ bands in Europe and at 850 MHz and 1.9 GHZ in the United States. In addition to voice functionality (e.g., via GSM), long-range communications 154 may operate to establish wireless data communication sessions, such as General Message Radio Service (GPRS) sessions and/or Universal Mobile Telecommunications System (UMTS) sessions. Long-range communications 154 may also operate to transmit and receive text messages, such as via the short messaging service (SMS), and/or multimedia content via multimedia messaging service (MMS) messages.

As a subset of long-range communications 154, or alternatively operating as an independent module separately coupled to processor 150, broadcast receivers 156 allows WCD 100 to receive unsolicited wireless communication via mediums such as Digital Video Broadcast for Handheld Apparatuses (DVB-H). Transmissions may be encoded so that only certain apparatuses may access transmission content, and may contain text, audio or video information. In at least one example, WCD 100 may receive broadcasts and/or information within the broadcast signal to determine if the apparatus is permitted to view the received content.

Short-range communications 158 may support the exchange of information across short-range wireless networks. As described above and depicted in FIG. 1B, examples of such short-range communications 158 are not limited to Bluetooth™, Ultra Low Power Bluetooth™ (ULP-BT), Wireless Local Area Network (WLAN), Ultra-Wide Band (UWB) and Wireless Universal Serial Bus (WUSB) connections. Short-range communications 158 may perform functions related to the establishment of short-range connections, as well as processing related to the transmission and reception of information via such exemplary connections.

Short-range input device 166, also depicted in FIG. 1B, may provide functionality related to the short-range scanning of machine-readable data (e.g., Near Field Communication (NFC)). For example, processor 150 may control short-range input device 166 to generate Radio Frequency (RF) scanning signals for activating a Radio Frequency Identification (RFID) transponder, and may in turn control the reception of signals from an active transponder. Other short-range scanning methods for reading machine-readable data that may be supported by short-range input apparatus 166 are not limited to Infra-Red (IR) communication, linear and 2-D (e.g., Quick Response (QR)) bar code readers (including processes related to interpreting universal product codes (UPC) labels), and optical character recognition devices for reading magnetic, Ultraviolet (UV), conductive or other types of coded data that may be provided in a tag using suitable ink. In order for short-range input apparatus 166 to scan the aforementioned types of machine-readable data, the input device may include optical detectors, magnetic detectors, Charge Coupled Devices (CCDs) or other sensors known in the art for interpreting machine-readable information.

As further shown in FIG. 1B, user interface 160 may also be coupled to processor 150. User interface 160 may facilitate the exchange of information with a user of an apparatus. User interface 160, as shown, may include user input 162 and user output 164. User input 162 may include one or more components that allow a user to input data into WCD 100. Examples of such components include keypads, touch screens, microphones, etc. User output 164 may allow a user to obtain information from WCD 100. Thus, user output portion 164 may include various components, such as a display, Light Emitting Diodes (LED), tactile emitters, audio speakers, etc. Exemplary displays may include Liquid Crystal Displays (LCDs) and other types of video displays.

WCD 100 may also include one or more transponders 168. A transponder may be an essentially passive apparatus that may be programmed by processor 150 with information to be delivered in response to a scan from an outside source. For example, an RFID scanner mounted in an entryway may continuously emit radio frequency waves. When an apparatus containing transponder 168 passes through the entryway, the transponder may be energized and may respond with information identifying the apparatus, person, security information (e.g., security codes), etc. In addition, a reader may be mounted (e.g., as discussed above with regard to examples of short-range input device 166) in WCD 100 so that it can read information from other transponders in the vicinity.

Hardware corresponding to communications sections 154, 156, 158 and 166 provide for the transmission and reception of signals. Accordingly, these sections may include components (e.g., electronics) that perform functions such as modulation, demodulation, amplification, and filtering. These sections may be locally controlled, or may be controlled by processor 150 in accordance with software communication components stored in memory 152.

The elements shown in FIG. 1B may be constituted and coupled according to various techniques in order to produce the functionality described in FIG. 1A. One such technique involves coupling separate hardware components corresponding to processor 150, communications sections 154, 156 and 158, memory 152, short-range input device 166, user interface 160, transponder 168, etc. through one or more wired or wireless bus interfaces. Alternatively, any and/or all of the individual components may be replaced by an integrated circuit in the form of a programmable logic apparatus, gate array, ASIC, multi-chip module, etc. programmed to replicate the functions of the stand-alone components. Each of these components may be coupled to a power source, such as a removable and/or rechargeable battery (not shown).

During exemplary apparatus operation, user interface 160 may interact with one or more communication software components (e.g., stored in memory 152) that may provide for the establishment of communication service sessions using long-range communications 154 and/or short-range communications 158. The communication utility software components may include various routines that allow for the transmission and reception of information and services from remote apparatuses according to mediums such as the Wireless Application Medium (WAP), Hypertext Markup Language (HTML) variants like Compact HTML (CHTML), etc.

### II. Wireless Communication Mediums

In accordance with at least one exemplary embodiment, the present invention may be implemented with a short-range wireless communication medium. Bluetooth™ is an example of a commonly employed short-range wireless technology. A Bluetooth™-enabled WCD may transmit and receive data, for example, at a rate of 720 Kbps within a range of 10 meters, and may transmit up to 100 meters with additional power boosting. Current Bluetooth™-enabled apparatuses may operate at a nominal rate of 1 Mbps. A user does not have to actively instigate a Bluetooth™ network. Instead, a plurality of apparatuses within communication range of each other may automatically form a network group called a “piconet”. Any apparatus may promote itself to be the master of the piconet, allowing it to manage data exchanges between up to seven “active” slaves and 255 “parked” slaves. Active slaves may exchange data based on the clock timing of the master. Parked slaves may monitor a beacon signal in order to stay synchronized with the master apparatus, and wait for one of the seven active slots to become available. The networked Bluetooth™ apparatuses may continually switch between active and power saving modes in order to conserve resources when not communicating with other piconet members. In addition to Bluetooth™ other popular short-range wireless networks include WLAN (of which “Wi-Fi” local access points communicating in accordance with the IEEE 802.11 standard, is an example), WUSB, UWB, ZigBee (802.15.4, 802.15.4a), ULP-BT and UHF RFID.

The present invention, in accordance with various exemplary embodiments, may be implemented with any communication configuration enabled to operate in a manner similar to the above identified exemplary communication mediums. While ULP-BT will be used for the sake of explanation in the following disclosure, as previously set forth, the following exemplary embodiments of the present invention are not specifically limited to this wireless communication medium. ULP-BT is an open standard industry initiative that was initially called Wibree at its introduction, but has since been adopted by the Bluetooth™ Users Group for use in extending local connectivity to small apparatuses. ULP-BT may enable close range communication with Bluetooth™-like performance of 1 Mbps in the 0-10 meter range. ULP-BT may be optimal for installations requiring extremely low power consumption, small size and low cost. ULP-BT may be implemented either as stand-alone chip or as Bluetooth™ ULP-BT dual-mode chip.

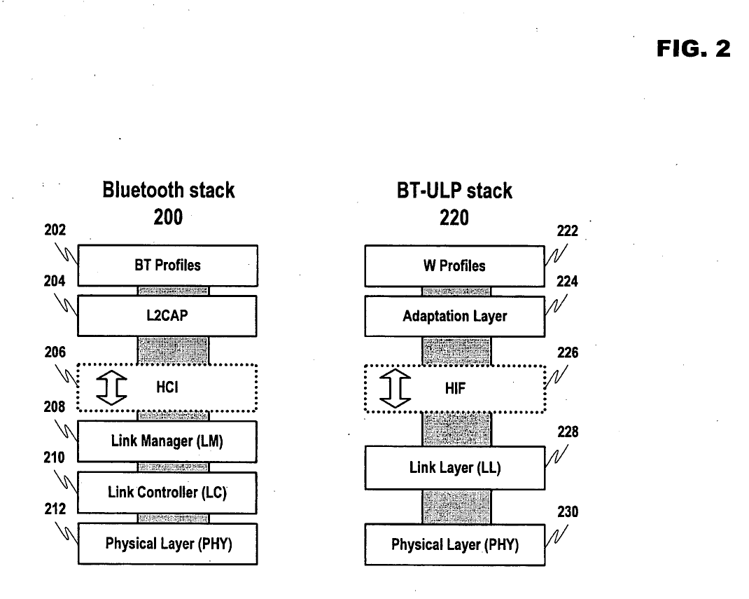

Now referring to FIG. 2, an exemplary Bluetooth™ protocol stack and an exemplary ULP-BT protocol stack are shown. Bluetooth™ stack 200 may include elements that convey information from a system level to a physical layer where it may then be transmitted wirelessly to another apparatus. At the top level, BT Profiles 202 include at least a description of a known peripheral apparatuses that may be wirelessly coupled to WCD 100, or an application that may utilize Bluetooth™ in order to engage in wireless communication with a peripheral apparatus. The use of the phrase “peripheral apparatuses” is not intended to limit the scope of the present invention, and is used only to represent any apparatus external to WCD 100 that is also capable of wirelessly communicating with WCD 100. Bluetooth™ profiles corresponding to other apparatuses may be established, for example, through a pairing process wherein identification and connection information for a peripheral apparatus may be received by WCD 100 by polling the other apparatus. This information may then be saved in order to expedite the connection to the apparatus at a later time.

After the application and/or target peripheral apparatus (or apparatuses) have been established, any information to be sent must be prepared for transmission. L2CAP level 204 may include at least a logical link controller and adaptation protocol. This protocol may support higher level protocol multiplexing message segmentation and reassembly, and the conveying of quality of service information. The information prepared by L2CAP level 204 may then be passed to an application-optional host controller interface (HCI) 206. This layer may provide a command interface to the lower link manager protocol (LMP) layers, link manager (LM) 208 and link controller (LC) 210. LM 208 may establish the link setup, authentication, link configuration and other protocols related to establishing a wireless link between two or more apparatuses. Further, LC 210 may manage active links between two or more apparatuses by handling low-level baseband protocols. Wireless communication may then be established and conducted using hardware (modem, antenna, etc.) residing in physical layer (PHY) 212. Of course, the above identified layers of Bluetooth™ stack 200 may also be utilized in an order reversed from that disclosed above in order to receive a wireless transmission into WCD 100 from a peripheral apparatus.

The layers in the standalone ULP-BT stack 220 are similar to the elements previously described. However, due to the relative simplicity of ULP-BT when compared to Bluetooth™, there may actually be fewer layers utilized to achieve wireless communication. ULP-BT Profiles 222, similar to the profiles used in Bluetooth™, may specify applications that can use ULP-BT for communication, as well as peripheral apparatuses with which a ULP-BT modem may wirelessly communicate. An adaptation layer 224 may be used to prepare the information for transmission via wireless communication. Adaptation layer 224 may be, for example, a Profile Adaptation Layer (PAL) or an L2CAP similar to Bluetooth™, but configured for simplified and/or low-power operation. Host interface (HIF) layer 226 may provide an interface between the upper layers communicating with applications and schedulers in WCD 100, and the lower layers of the ULP-BT stack 220 which establish and maintain the links to peripheral apparatuses. Lower layers of the ULP-BT stack 220 may further include at least link layer (LL) 228. LL 228 may both establish and maintain wireless communications with other wireless enabled apparatuses through the use of Physical Layer (PHY) 230. However, LL 228 as shown in the ULP-BT stack may differ significantly from LM 208 and LC 210 in Bluetooth™.

### III. Dual-Mode Modem

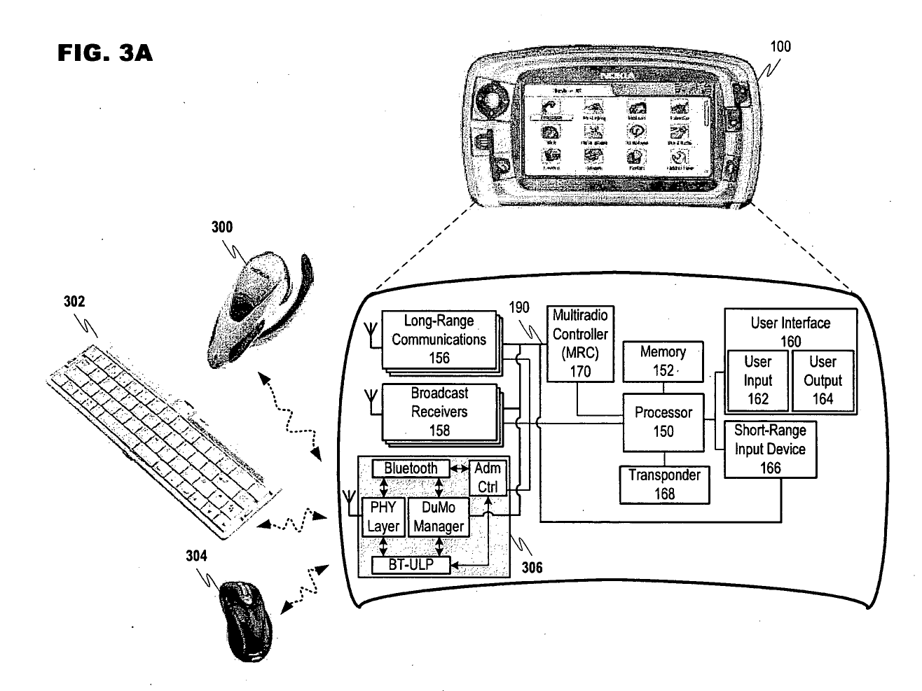

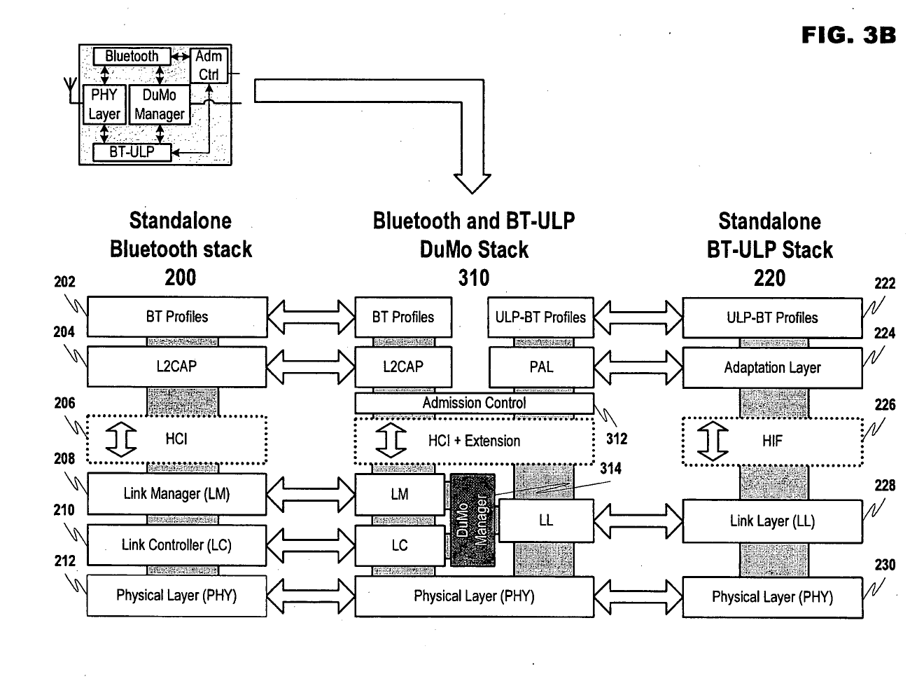

FIG. 3A discloses an exemplary communication configuration in accordance with at least one embodiment of the present invention. Again, in this example the three peripheral apparatuses (300, 302 and 304) are attempting concurrent communication with WCD 100 through dual-mode radio modem 306. Radio modem 306 may include local control resources for managing both “radios” (e.g., Bluetooth™ and ULP-BT software based radio control stacks) attempting to use PHY layer resources of dual-mode radio modem 306. In this example, radio modem 306 may include at least two radio stacks or radio protocols (labeled “Bluetooth” and “ULP-BT”) that may share PHY layer resources (e.g., hardware resources, antenna, etc.) of radio modem 306. The local control resources may include an admission controller (“Adm Ctrl”) and a dual-mode controller (“DuMo Manager”). These local control resources may be embodied as a software program and/or in hardware form (e.g., logic apparatus, gate array, MCM, ASIC, etc.) in a dual-mode radio modem interface, and the radio modem interface may be coupled to, or alternatively, embedded in dual-mode radio modem 306. The interaction of these control resources with the protocols utilizing dual-mode radio modem 306 is explained below.

In FIG. 3B, an exemplary combination of the two individual radio protocol stacks discussed in FIG. 2 into a single dual-mode communication entity is now disclosed. Local control may be implemented by at least an admission control 312 and a DuMo manager 314. The two previously described standalone protocol stacks are shown to establish the individual elements that may be incorporated into integrated dual-mode entity 310. For a more specific discussion of the functioning of admission control 312 and a DuMo manager 314 in terms of managing the operations of dual-mode modem 306, please refer to application Ser. No. 11/538,310, filed Oct. 3, 2006, which is hereby incorporated by reference. Briefly, Admission control 312 may operate as a gateway for dual-mode radio modem 306 by filtering out Bluetooth™ and ULP-BT communication requests from other entities in WCD 100 that may result in conflicts. Scheduling information may also be provided by Multiradio controller (MRC) 170, wherein certain periods of operation are allocated to dual-mode radio modem 306 in view of the other active radio modems operating in WCD 100. This scheduling information may be passed down to both the HCI+ Extension level of the dual-mode stack and also to DuMo manager 314 for further processing. However, if scheduling information from MRC 170 is critical (e.g., delay-sensitive), it may be sent through MCS 190 via a direct connection to DuMo Manager 314. The information received by DuMo manager 314 may be used to create a schedule for dual-mode radio modem 300 allowing both Bluetooth™ and ULP-BT to operate substantially concurrently.

### IV. Protocol Stacks and Message Routing

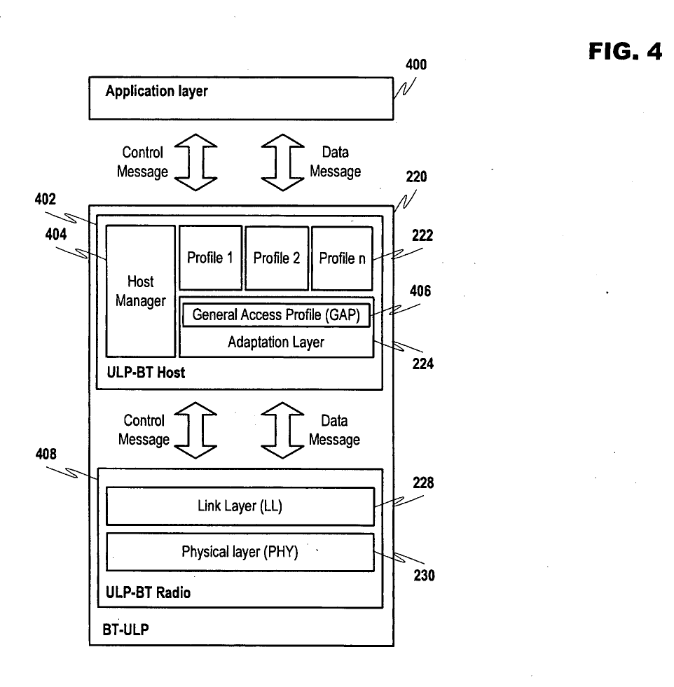

FIG. 4 discloses a more detailed example of the upper layers of the ULP-BT communication protocol. The ULP-BT system may include two parts: ULP-BT Radio 408 and ULP-BT Host 402. Connection between radio 408 and host 402 may pass through the HIF (Host Interface). Further, adaptation layer 224 may include at least General Access Profile (GAP) 406.

Application layer 400 may include, for example, various programs executable by a computing apparatus. Exemplary applications may include communication, entertainment or productivity programs running on WCD 100. An application may use ULP-BT Profiles 222 in ULP-BT (e.g. Profile 1, Profile 2, etc.) in order to send information into the ULP-BT protocol stack 220 in a transaction supervised by Host Manager 404. The information may then be prepared by adaptation layer 224 and GAP 406 for routing to ULP-BT radio 408, wherein LL 228 may both establish new wireless connections and manage existing connections with peripheral apparatuses through the resources (modem, antenna, etc.) included in PHY layer 230.

V. Communication Between an Advertiser and at Least One Receiving Apparatus with Connection.

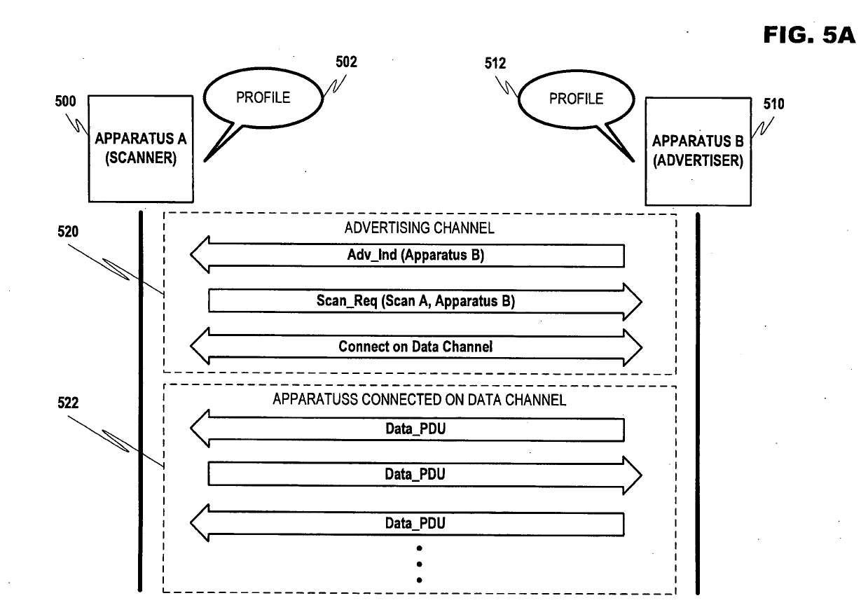

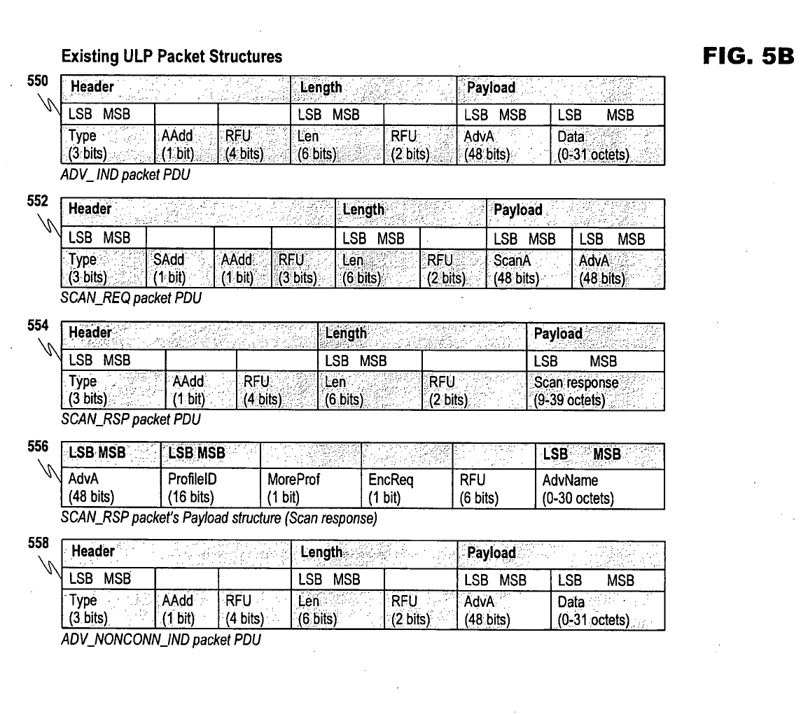

Referring now to FIG. 5A, an exemplary communication between apparatuses, including the establishment of a formal network connection, is disclosed. Apparatus A 500 (hereafter referred to as scanner 500) may initiate wireless communication with Apparatus B (hereafter referred to as advertiser 510) after receiving a broadcast signal from advertiser 510. The initiation of wireless communication by scanner 500 and subsequent interaction between these apparatuses may be automatic or manual (e.g., including at least some intervention from user). Apparatuses 500 and 510 may also include communication profiles 502 and 512, respectively. Further, these apparatuses may be known to each other before the interaction shown in FIG. 5A (e.g., they may be two apparatuses owned by the same user), or alternatively, they may have previously been unknown to each other, such as in a exemplary scenario where a user in possession of WCD 100 moves into transmission range of advertiser 510 at a public location, such as a shopping mall.

As set forth above, advertiser 510 may broadcast a signal to all apparatuses within transmission range. The advertising signal may be repeated periodically, may be triggered by another apparatus (e.g., a motion sensor) alerting advertiser 510 to the presence of a potential scanning apparatus 500, etc. Information included in the broadcast signal, ADV_IND, may include introductory information at least identifying advertiser 510, for example in the form of a dedicated apparatus name, and possibly also including profile information. This identification may be public (e.g., the actual fixed apparatus address) or may be private (e.g., a dynamically generated pseudonym that receiving apparatuses can decode, using an algorithm, and compare to stored information to determine whether advertiser 510 is the same device as previously encountered without disclosing the public address of the advertiser). For security reasons, there are few scenarios where an apparatus would actually need to disclose it's public address. The ADV_IND message may be broadcast, according to at least one embodiment of the present invention, on an advertising channel. All potential scanners 500 may be aware that any broadcast messages should be expected on the designated advertising channel (also, in some instance, called the initialization channel). In a more specific scenario, ULP-BT may include three predetermined advertising channels. Therefore, scanner 500 and advertiser 510, when using ULP-BT, may be able to utilize one or more of the three advertising channels in a strategy to enhance broadcast coverage in view of advertising channel availability.

Scanner 500, upon receiving the ADV_IND message from advertiser 510, may either ignore the message and continue listening for another ADV_IND message with different content, or initiate communications with advertiser 510. At least one scenario where scanner 500 may continue to listen to the advertising signal may be in order to collect all available introductory information from advertiser 510 (e.g., advertiser identification and available profile information). Scanner 500 may respond, for example, if advertiser 510 is identified and/or recognized as having information of interest to a apparatus user. This recognition may occur automatically, or alternatively, the user may be alerted to the presence of advertiser 510, whereby the user may act manually by prompting scanner 500 (e.g., WCD 100) to respond to the advertising message. Alternatively, scanner 500 may respond simply by acknowledging the reception of information from advertiser 510. Scanner 500 may then transmit a message requesting a formal network connection with advertiser 510. If advertiser 510 is in a condition to honor the request (e.g., advertiser 510 is, for example, not already connected to another apparatus/exceeded maximum connections, has adequate power, etc.) a formal network connection may be established between the two apparatuses 500 and 510.

A formal network connection, such as shown in FIG. 5A (“APPARATUSES CONNECTED ON DATA CHANNEL”), will not be established on the advertising channel. Instead, a different channel specifically for the subsequent exchange of data may be selected by one or both of the apparatuses. This new connection will allow the apparatuses to exchange information without occupying the advertising channel. The exchange of data (e.g., Data_PDU) may continue until scanner 500 receives all data requested from advertiser 510, or alternatively, until either apparatus breaks the link (e.g., out of range, power limitation, interference, etc.)

### VI. Exemplary ULP-BT Messaging.

FIG. 5B discloses five examples of ULP message structures (e.g., that may be used, for example, as introduction messages) that may be usable with various embodiments of the present invention. For example, connectable advertising events in BT-ULP may contain ADV_IND message transmissions (e.g., 550) from advertiser 510. These messages may include a header section to identify and direct the message, and a payload section including message data. As shown in FIG. 5B, the header may include identification information for ADV_IND message 550, including Type, AAdd and RFU. The least significant bit (LSB) and most significant bit (MSB) are also indicated in exemplary ADV_IN message 550. AAdd in the header of ADV_IND may indicate whether the advertiser's address in the AdvA field is public (AAdd=0) or private (AAdd=1). Len may indicate the size of the payload (e.g., AdvA and Data) in octets. The two MSB of the Length field are reserved bits and may be set to zero and ignored upon receipt. The payload field shall comprise of AdvA and Data fields. The AdvA field shall contain the advertiser's apparatus address. The data field may contain any data.

Scanner 500 may respond to ADV_IND message 550 and may request further information about advertiser 510 with a SCAN_REQ message 552. Scanner 500 may request a LL 228 connection to advertiser 510 using a CONNECT_REQ message. Scanner 500 is allowed to transmit their own request messages only after successfully received ADV_IND messages.

After every ADV_IND message transmission, advertiser 510 shall listen for a SCAN_REQ and CONNECT_REQ message on the same channel. If no message is received on the advertising channel, Advertiser 510 may move to the next predetermined advertising channel to transmit another ADV_IND message, or to close the event. The time between the beginning of two consecutive ADV_IND messages within an event shall be less than or equal to 1.5 ms. However, if advertiser 510 receives a correct SCAN_REQ message 552 from an approved or recognized apparatus (e.g., scanner 500), it may reply with SCAN_RSP message 554 after the end of the SCAN_REQ message. Otherwise, the message may be ignored if the apparatus is not approved. After SCAN_RSP 554 transmission, advertiser 510 may either move to the next used advertising channel to transmit another ADV_IND message, or to close the event.

An exemplary payload for SCAN_RSP 554 is shown in FIG. 5B at 556. The AdvA field may contain the apparatus address of advertiser 510 (the apparatus from which the message was transmitted). The ProfileID may be used to indicate one profile supported by advertiser 510. MoreProf may be used to indicate whether advertiser 510 also supports other profiles in addition to the one indicated by the ProfileID. If MoreProf is set to zero, this may indicate that no other profiles are supported. If it is set to one, this may indicate that advertiser 510 also supports other profiles. EncReq may be set to indicate whether advertiser 510 requests possible LL 228 connections to be created in an open or encrypted mode. For example, EncReq may be set to zero to indicate open (unencrypted) connections and may be set to one to indicate that the connections should be in encrypted mode. The RFU bits may be set to zero and ignored upon receipt. AdvName may contain a user or application-given advertiser name (e.g., a name string from left to right coded in UTF-8 format). It is important to note that the LL of scanner 500 is not being requested to react to any of the values in the payload field (e.g., EncReq) but instead, all values are intended for use by advertiser 510.

A connectionless advertising event may contain information only from advertiser 510. This message may be used, for example, to broadcast information from advertiser 510 without the need of establishing a formal connection to another apparatus (e.g., scanner 500). Advertiser 510 may transmit only ADV_NONCONN_IND messages 558, and may ignore any request for further information about advertiser 510 or for a LL connection from other apparatuses. Scanner 500 may not actively participate in this transaction (e.g., send messages). Each event shall contain one ADV_NONCONN_IND message 558 on every used advertising channel. Advertising channel usage may be determined by advertiser 510. After every ADV_NONCONN_IND message 558 transmission, advertiser 510 may either move to the next used advertising channel to transmit another ADV_NONCONN_IND message 558, or to close the event. An event may also be closed, for example, after completion of advertising message transmission in every used advertising channel.

ADV_NONCONN_IND message 558 may have a structure and content as shown in FIG. 5B. Type may be set to 0x1. AAdd in the header may indicate whether the address of Advertiser 510 in the AdvA field is public (e.g., AAdd=0) or private (e.g., AAdd=1). Len may indicate the size of the payload (AdvA and Data) in octets. The two MSB of the Length field may be reserved bits, and may further be set to zero and ignored upon receipt. The payload may include a 48-bit AdvA field and up to 31 octets of data. The AdvA field may contain the address of advertiser 510. The data field can contain any data from the host of advertiser 510.

### VII. Multiple Profiles in a Single Apparatus.

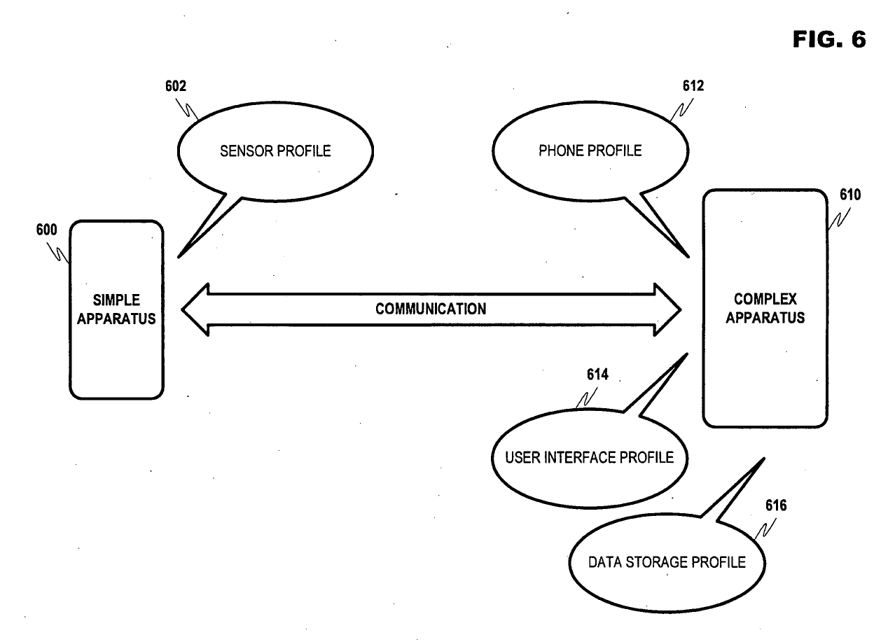

FIG. 6 discloses an exemplary scenario wherein apparatuses may communicate via a wireless communication medium. This exemplary scenario shows two different examples of apparatuses including simple apparatus 600 and complex apparatus 610. The present invention is not limited to this interaction, as FIG. 6 is merely representative of the level of complexity of apparatuses that may participate in wireless communication. Exemplary simple apparatus 600 may be a low power apparatus like a sensor. In one instance a temperature sensor may send information related to current sensed temperatures, however, simpler sensors also may exist such as touch or motion sensors that simply transmit a bit condition depending on whether the sensor has been triggered or not.

In view of this example, simple apparatus 600 may include only one profile (e.g., sensor profile 602). Apparatuses wishing to obtain information from simple apparatus 600 may utilize this profile for establishing communication. On the other hand, complex apparatus 610 may be, for example, a wireless communicator, laptop or palmtop computer, personal digital assistant (PDA), a cellular handset, etc. As complex apparatus 610 may include many features, such as one or more of the features discussed above with respect to WCD 100, multiple profiles may exist on the apparatus. Exemplary profiles as shown in FIG. 6 may include, but are not limited to, phone profile 612, user interface profile 614 and data storage profile 616. Each of these profiles may be accessed by another apparatus, and with each profile the resulting behavior of complex apparatus 610 may vary. For example, complex apparatus 610 may act as a communication apparatus when phone profile 612 is accessed by another apparatus. This may, for example, allow the other apparatus (e.g., a laptop) to access the internet via GPRS. Further, user interface profile 614 may allow complex apparatus 610 to act as a data entry apparatus for another apparatus without a user interface, and data storage profile 616 may allow data to be transmitted via wireless communication to complex apparatus 610 so that it may be written to memory, for example, for sending photos from a digital camera that is unable to write to removable media (e.g., in a cellular handset) to a apparatus capable of writing to such media.

### VIII. Advertising Using Exemplary MIA Strategies.

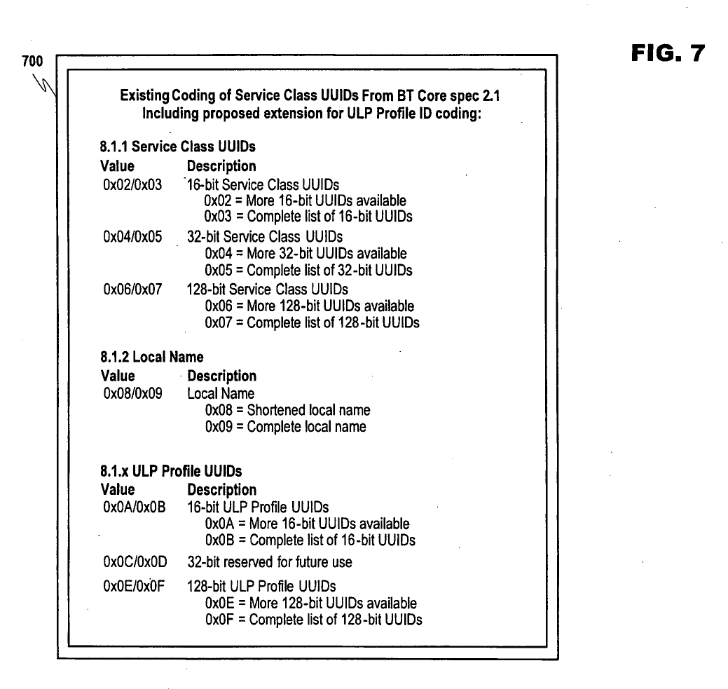

In view of the example of FIG. 6, the ability to advertise introductory information including multiple profiles may be advantageous in at least the facilitation of access to all of the functionality in a more complex apparatus. In accordance with various exemplary embodiments of the present invention, FIG. 7 discloses examples of proposed universally unique identifiers (UUIDs). For example, table 700 describes Existing Coding of Service Class UUIDs from Bluetooth™ core specification 2.1 including possible extensions for ULP-BT profile coding.

The profile UUID attribute may hold a UUID that can identify a single profile that this apparatus supports. This attribute can be repeated a number of times, enabling one or more profiles to be enumerated. For example, if the attribute value is 2 octets in size, then this UUID shall be interpreted as a 16 bit ULP-BT UUID. If the attribute value is 16 octets in size, then this UUID shall be interpreted as a 128 bit UUID. All attribute handles for a given Profile may be sequential. In some instances there may be gaps in the attribute handles for a given profile, but other profile UUIDs cannot be placed in the middle of another profile's attribute handles. The Profile UUID attribute shall have the smallest handle number in the profile range.

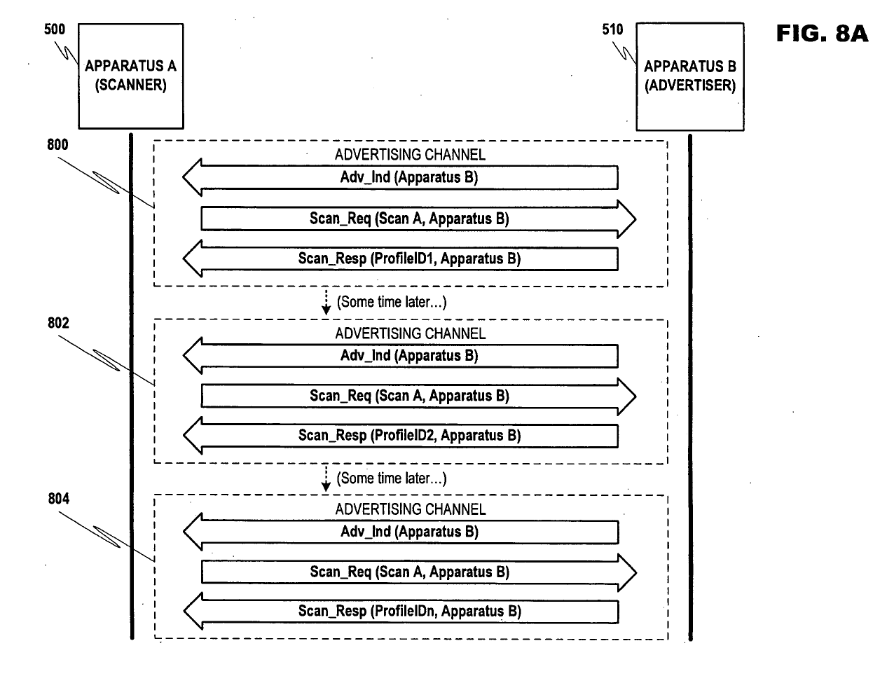

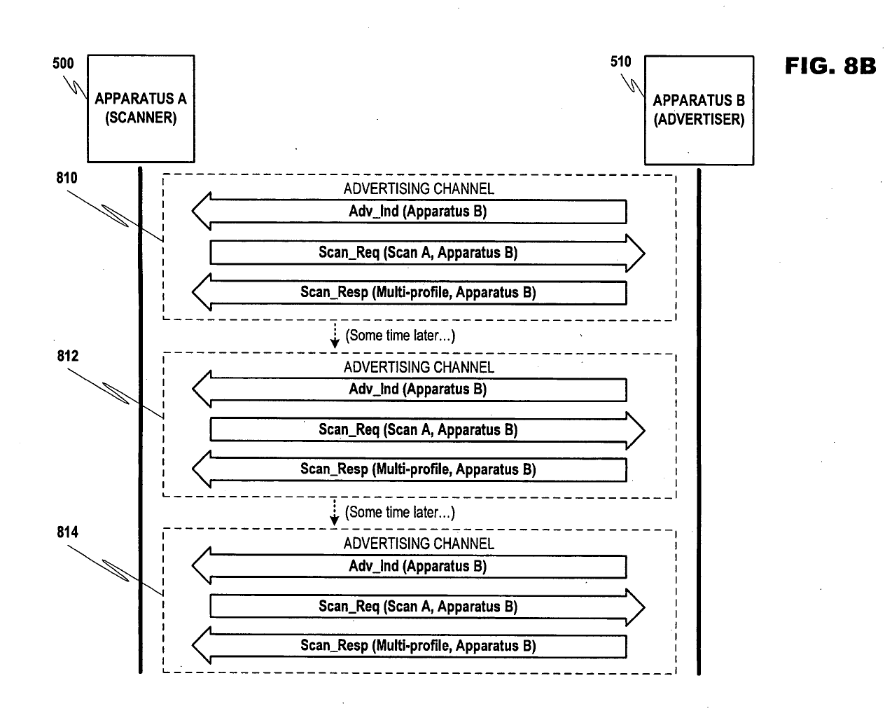

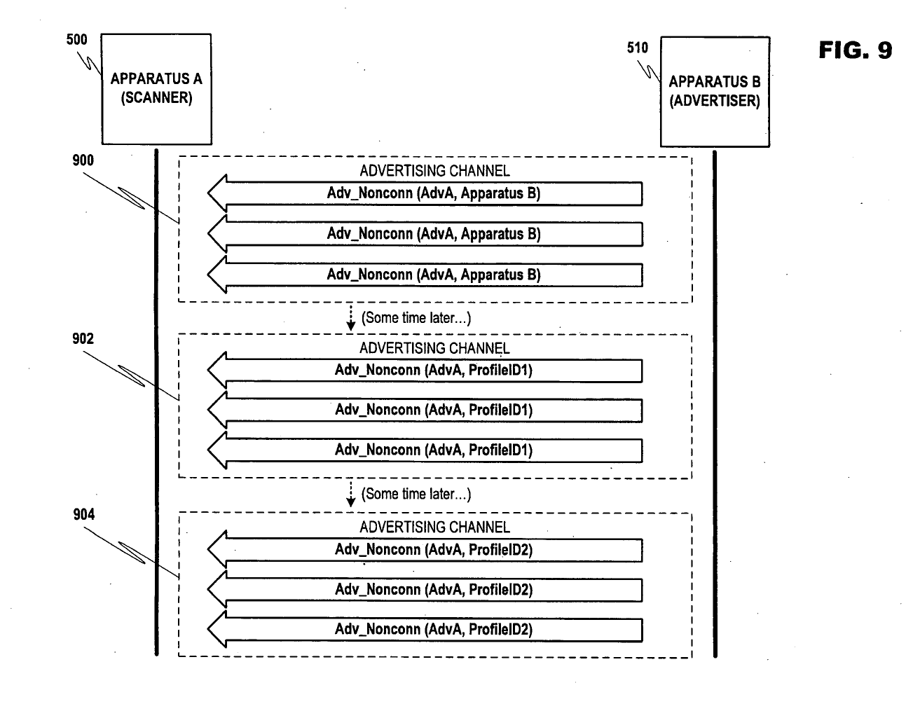

The profile UUID attribute described above may be used to communicate identification data to encountered apparatuses (e.g., scanner 500), as well as information related to various profiles that may be available in a apparatus (e.g., advertiser 510). The challenge then becomes to devise a strategy for communicating this information. FIG. 8A-9 disclose various MIA strategies usable in accordance with various embodiments of the present invention.

FIG. 8A-8B discloses examples of conveying introductory information including multiple profile information to another apparatus over an established wireless link. In this MIA strategy, advertiser 510 may first issue ADV_IND message 550 as shown at 800. This message may include at least identification information regarding advertiser 510. When scanner 500 receives this message, and if the identification information for advertiser 510 is recognized, scanner 500 may respond with SCAN_REQ message 552 including at least identification information for scanner 500 in order to establish a wireless link. Advertiser 510 may then send an introduction message (e.g., SCAN_RESP message 554) in response to SCAN_REQ message 552 including information regarding a first available communication profile. Scanner 500 may then elect to access this profile in advertiser 510 if, for example, the functionality provided by the communication profile is desired or required by scanner 500. Alternatively, scanner 500 may elect to take no action (e.g., does not access profile) if the advertised profile does not meet the requirements of scanner 510. Moreover, another option may include the MoreProf bit being set in the ADV_IND message. In response to this indicator, scanner 500 may decide to send another SCAN_REQ message to check for other profile UUIDs that are available in the advertiser.

As further depicted in FIG. 8A, another wireless transaction may commence after some period of time has passed. This is shown, for example, at 802. The period of time may be a predetermined fixed period, or may be a period computed based on various parameters such as advertising apparatus resources (e.g., battery life or number of active connections), connection characteristics (e.g., number of connections), the identity of previously coupled scanner 500, etc. The example disclosed at 802 is similar to the example previously discussed above at 800 except that the advertised introductory information now references a different profile. Again, scanner 500 may receive the introductory information including the new profile, and may elect to access functionality defined by this profile. Otherwise, as shown at 804 advertiser 510 may continue to cycle through the various profiles available on advertiser 510 until a profile is selected or until all profiles have been included in the advertised introductory information. The order of including profiles in the advertised introductory information, or the decision as to whether a profile should be included, may depend on various factors, for example, the frequency of use of each profile, the current state of resources (e.g., power, processing, etc.) in advertiser 510, other active communication mediums and/or connections in advertiser 510, manual settings established in the apparatus, in view of the introductory information transmitted in the previous SCAN_RESP which identified an available profile from a plurality of available profiles, etc. After all of the communication profiles available in advertiser 510 have been included in an advertisement, the process may began again with the first profile that was advertised, or alternatively advertiser 510 may enter an alternate mode (e.g., advertiser 510 may enter a resource conservation or sleep mode for some period of time in order to conserve energy within the apparatus).

Now referring to FIG. 8B, an alternative MIA strategy in accordance with at least one embodiment of the present invention is now disclosed. SCAN_RESP message 554 in examples 810-814 may include, in addition to advertiser identification information, information that may indicate the existence of multiple profiles in advertiser 500. This may be accomplished, for example, using the MoreProf bit in the previously described SCAN_RESP message 556. Setting this bit may serve as an indicator to scanner 500 that more than one communication profile is available for communicating with advertiser 510. Scanner 500 may then request additional information on the available communication profiles from advertiser 510. In an alternative configuration, information identifying all of the available communication profiles in advertiser 510 may be sent as part of SCAN_RSP message 556, which scanner 500 may then use to select and access a particular communication profile.

FIG. 9 discloses a different MIA strategy in accordance with another exemplary configuration of the present invention. The strategy of FIG. 9 may utilize ADV_NONCONN messages 558 to convey identification and available communication profile information, in the same or subsequent ADV_NONCONN messages 558, from advertiser 510 to apparatuses like scanner 500 without having to first negotiate a formal communication link. In this way, at least the identity of advertiser 510 may be known to one or more scanners 500 without advertiser 510 expending the resources necessary to establish a formal wireless connection with each apparatus. Each scanner 500 may then interpret the information obtained from ADV_NONCONN messages 558 in order to determine whether to interact with advertiser 510. A formal connection may then be instituted if all of the relevant introductory information has been received. Otherwise, scanner 500 may continue to listen for messages from advertiser 500 to obtain more information such as, for example, information related to multiple communication profiles available in advertiser 510.

In example 900 disclosed in FIG. 9, advertiser 510 may send broadcast messages including at least advertiser identification information. Apparatuses listening on the advertising channel may receive the broadcast advertiser identification, and may further be informed as to upcoming messages such as, for example, communication profile information for advertiser 510. ADV_NONCONN messages 558 containing additional information (e.g., 902 and 904) may be identified, for example, by advertiser identification information matching what was previously received by scanner 500. In these examples, each ADV_NONCONN messages 558 is repeated three times, however, various embodiments of the present invention are not specifically limited to this number of broadcast messages, and may repeat messages in accordance with various factors such as a number of apparatuses, a new apparatus, interference sensed in the area, etc. Similar to the MIA strategy in FIG. 9, it may be possible to advertise using the same message pattern except with ADV_IND messages, though a formal connection would first be required.

In examples 902 and 904 of FIG. 9, ADV_NONCONN messages 558 are repeated including information about a particular profile available in advertiser 510. When a receiving apparatus (e.g., scanner 500) obtains information on a desired communication profile, it may then endeavor to establish a formal connection in order to access the functionality provided by the communication profile. For example, a sensor device (e.g., temperature sensor) may first repeatedly broadcast identification information, then profile information, which is followed by sensor data (e.g., current temperature). Scanner 500 may use this information to identify the temperature sensor, learn how to access current temperature information and then receive current temperature data. However, a formal connection is only required in such an instance, allowing advertiser 510 to continue broadcasting identification and available profile information repeatedly without waiting for a response from scanner 500. As set forth above, the advertising of particular profiles and the order in which the profiles are advertised, as well as the number of times to repeat ADV_NONCONN messages 558, and the action to take once all of the profiles have been advertised, may vary depending on the particular parameters/factors involved.

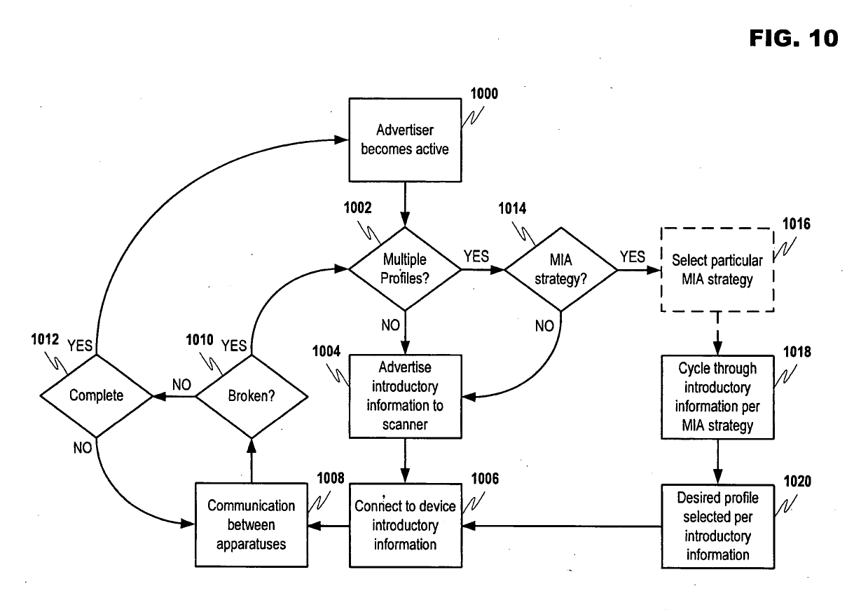

A flowchart for an exemplary process for advertising introductory information including information on one or more profiles available on an apparatus, in accordance with at least one exemplary embodiment of the present invention, is now disclosed with respect to FIG. 10. In step 1000 an advertiser may become active. This may occur due to an automated activation due to, for example, sensing the presence of other apparatuses in the area, or alternatively may be triggered by manual activation by a user. A determination may then be made in step 1002 as to whether more than one communication profile exists on the advertising apparatus. If there is only one profile, then in step 1004 introductory information including identification information for the advertiser and referencing the communication profile may be advertised to scanning apparatuses within transmission range of the wireless medium being used.

If a scanner desires to access the advertised profile, which may be visualized on a display in the scanner and may involve a user interaction, for example, for selecting a profile from the device information shown on the displayed user interface (e.g., sensor icon with the device name). Then in step 1006 a wireless link may be established between the scanner and advertiser to grant access to the profile. This communication may take place in step 1008. If the connection is determined to be broken in step 1010 due to, for example, interference, moving out of transmission range, communications being disabled in an apparatus, etc, then the process may return to step 1002 to reinitiate the advertising of the introductory information. However, if no break in communication is detected in step 1010, then the process may move to step 1012 where communication using the profile may continue (e.g., may return to step 1008) until completed. The process may return to step 1000 to wait for the advertising apparatus to again become active.

However, if a determination is made in step 1002 that multiple communication profiles are available in an advertiser, then in step 1014 an inquiry may be made as to whether the advertiser is enabled to advertise introductory information including multiple profiles (e.g., whether the apparatus can implement a MIA strategy). If this functionality is not available, then the apparatus may only advertise using a single communication profile, which is represented by return to step 1004. On the other hand, if the ability to advertise multiple profiles is available, then in step 1016 a MIA strategy may be selected. Step 1016 has been represented as optional (i.e., with a dotted outline) as the selection of a MIA strategy would only be necessary in the instance where the advertiser has more than one MIA strategy available.

In step 1018, the advertiser may cycle the advertised introductory information by including, for example, information related to advertiser identification and each available communication profile in accordance with any of the previously described connection-based or connectionless MIA strategies. The order of the advertised profiles may be determined in view of apparatus, profile or environmental parameters. Apparatus-related parameters may include, for example, power level, current apparatus mode (active, high security, sleep, etc.), a number of active radios or active communication links in the apparatus, a manually or automatically set configuration in the apparatus, etc. Profile-related parameters may include, for example, the frequency that a profile is accessed, the resources required to support each profile, a number of devices current accessing each profile, etc. Environmental-related parameters may include, for example, general electronic signal interference or other active communication signals detected near an advertiser, other devices sensed in proximity to an advertiser, etc. A scanner may receive advertised introductory information, and based on the communication profile information included in the introductory information, may make a determination as to a profile to select and access in step 1020. The process may then proceed to step 1006 where a connection may be established for granting the scanner access to the selected communication profile.

Accordingly, it will be apparent to persons skilled in the relevant art that various changes in form a and detail can be made therein without departing from the spirit and scope of the invention. The breadth and scope of the present invention should not be limited by any of the above-described exemplary embodiments, but should be defined only in accordance with the following claims and their equivalents.

What is claimed:

1. A method, comprising:
determining if an apparatus includes a plurality of communication profiles;
if the apparatus includes a plurality of communication profiles, determining if the apparatus includes at least one multiple introduction advertising strategy;
if the apparatus includes more than one multiple introduction advertising strategy, selecting the at least one multiple introduction advertising strategy; and
advertising the plurality of communication profiles in accordance with the at least one multiple introduction advertising strategy.

2. The method of claim 1, wherein the at least one multiple introduction strategy comprises transmitting introduction messages from the apparatus, at least one of the introduction messages including apparatus identification information.

3. The method of claim 2, wherein the at least one introduction message further includes at least one of an identification of the plurality of communication profiles or a flag indicating that a plurality of communication profiles are available.

4. The method of claim 1, wherein the at least one multiple introduction advertising strategy comprises transmitting introduction messages from the apparatus based on a pattern, each introduction message advertising information regarding at least one of the plurality of communication profiles.

5. The method of claim 4, wherein the pattern controls the apparatus to advertise each of the of the plurality of communication profiles in a particular order.

6. The method of claim 5, wherein the particular order is determined in view of at least one of apparatus, profile or environmental parameters.

7. The method of claim 1, wherein a wireless connection with at least one other apparatus is established before advertising the plurality of communication profiles.

8. The method of claim 1, wherein the plurality of communication profiles are advertised by wirelessly repeating a connectionless broadcast message in a predetermined pattern.

9. A computer program product comprising a computer readable medium having computer executable program code embodied in said medium, comprising:
a computer executable program code configured to determine if an apparatus includes a plurality of communication profiles;
a computer executable program code configured to, if the apparatus includes a plurality of communication profiles, determine if the apparatus includes at least one multiple introduction advertising strategy;
a computer executable program code configured to, if the apparatus includes more than one multiple introduction advertising strategy, select the at least one multiple introduction advertising strategy; and
a computer executable program code configured to advertise the plurality of communication profiles in accordance with the at least one multiple introduction advertising strategy.

10. The computer program product of claim 9, wherein the at least one multiple introduction strategy comprises transmitting introduction messages from the apparatus, at least one of the introduction messages including apparatus identification information.

11. The computer program product of claim 9, wherein the at least one introduction message further includes at least one of an identification of the plurality of communication profiles or a flag indicating that a plurality of communication profiles are available.

12. The computer program product of claim 9, wherein the at least one multiple introduction advertising strategy comprises transmitting introduction messages from the apparatus based on a pattern, each introduction message advertising information regarding at least one of the plurality of communication profiles.

13. The computer program product of claim 12, wherein the pattern controls the apparatus to advertise each of the of the plurality of communication profiles in a particular order.

14. The computer program product of claim 13, wherein the particular order is determined in view of at least one of apparatus, profile or environmental parameters.

15. The computer program product of claim 9, wherein a wireless connection with at least one other apparatus is established before advertising the plurality of communication profiles.

16. The computer program product of claim 9, wherein the plurality of communication profiles are advertised by wirelessly repeating a connectionless broadcast message in a predetermined pattern.

17. An apparatus, comprising:
at least one communication module;
at least one memory configured to store communication profile information; and
a processor, the processor being configured to:
determine if an apparatus includes a plurality of communication profiles;
if the apparatus includes a plurality of communication profiles, determine if the apparatus includes at least one multiple introduction advertising strategy;
if the apparatus includes more than one multiple introduction advertising strategy, select the at least one multiple introduction advertising strategy; and
advertise the plurality of communication profiles in accordance with the at least one multiple introduction advertising strategy.

18. The apparatus of claim 17, wherein the at least one multiple introduction strategy comprises transmitting introduction messages from the apparatus, at least one of the introduction messages including apparatus identification information.

19. The apparatus of claim 18, wherein the at least one introduction message further includes at least one of an identification of the plurality of communication profiles or a flag indicating that a plurality of communication profiles are available.

20. The apparatus of claim 17, wherein the at least one multiple introduction advertising strategy comprises transmitting introduction messages from the apparatus based on a pattern, each introduction message advertising information regarding at least one of the plurality of communication profiles.

21. The apparatus of claim 20, wherein the pattern controls the apparatus to advertise each of the of the plurality of communication profiles in a particular order.

22. The apparatus of claim 21, wherein the particular order is determined in view of at least one of apparatus, profile or environmental parameters.

23. The apparatus of claim 17, wherein a wireless connection with at least one other apparatus is established before advertising the plurality of communication profiles.

24. The apparatus of claim 17, wherein the plurality of communication profiles are advertised by wirelessly repeating a connectionless broadcast message in a predetermined pattern.

25. An apparatus, comprising:
means for determining if an apparatus includes a plurality of communication profiles;
means for, if the apparatus includes a plurality of communication profiles, determining if the apparatus includes at least one multiple introduction advertising strategy;
means for, if the apparatus includes more than one multiple introduction advertising strategy, selecting the at least one multiple introduction advertising strategy; and
means for advertising the plurality of communication profiles in accordance with the at least one multiple introduction advertising strategy.

26. A system, comprising:
an advertising apparatus; and
at least one scanning apparatus;
the advertising apparatus determining if a plurality of communication profiles for granting access to advertising apparatus functionality to the at least one scanning apparatus are available, and if the advertising apparatus includes a plurality of communication profiles, determining if the advertising apparatus includes at least one multiple introduction advertising strategy;
the advertising apparatus selecting, if the apparatus includes more than one multiple introduction advertising strategy, the at least one multiple introduction advertising strategy, and advertising the plurality of communication profiles to the at least one scanning apparatus in accordance with the at least one multiple introduction advertising strategy.
